(19) United States
(12) Patent Application Publication
(10) Pub. No.: US 2010/0142681 A1
(43) Pub. Date: Jun. 10, 2010

(54) ARRANGEMENT FOR GENERATION OF X-RAY RADIATION WITH A LARGE REAL FOCUS AND A VIRTUAL FOCUS ADJUSTED ACCORDING TO REQUIREMENTS

(76) Inventor: Lars Lantto, Vittangi (SE)

Correspondence Address: YOUNG & THOMPSON, 209 Madison Street, Suite 500, Alexandria, VA, 22314, US

(21) Appl. No.: 12/598,662

(22) PCT Filed: May 5, 2008
(86) PCT No.: PCT/SE2008/050502

§ 371 Date: Nov. 3, 2009

(30) Foreign Application Priority Data
May 3, 2007 (SE) 0701057-2

(51) Int. Cl. H01J 35/14

(52) U.S. Cl. 378/138

(57) ABSTRACT

An arrangement for generating X-ray radiation includes an anode (9) formed as a part of a sphere, at least one virtual focus element (4) adapted to emit generated photons to create the useful beam field. The arrangement has a larger real focus than known X-ray tubes and arrangements for generating X-ray with an inclined anode surface, and achieves an increased radiation amount per unit of time, provided that the acceleration voltage and the electron density for each anode surface unit are equal for both arrangements. The virtual focus element (4) can be adapted to a specific field of application. Time- and geometry-related imaging errors may be avoided due to the high photon density and a focus which can be adapted to the requirements.

### FIELD OF THE INVENTION

The invention relates to generation of X-ray radiation principally for medical diagnostics and therapy, but also for use in other fields like material control within industry, and for luggage control within aviation.

### PRIOR ART

Among persons skilled in the art, known problems with the until now known X-ray tubes are geometric unsharpness due to focus size, and movement unsharpness when imaging moving human organs because of the relatively long time of exposure. Another known problem is the non-uniform photon energy distribution over the beam field.

All these problems have the same primary cause, namely the way of extracting photons from the anode surface. A number of improvements have been made, to the X-ray tubes over the years, to reduce the negative effects of the known problems. Among others, improvements have been made to minimize the size of the focus, and to make the tube voltage uniform, and to increase the tube current to increase the amount of photons per unit of time. However, these devices had to either decrease tube current, which has an influence on the number of photons per unit of time and thereby gives an increased risk of movement unsharpness, or increase focus size, which causes geometric unsharpness.

Previous known X-ray tubes with inclined anode surface causes both the total energy output and the energy per photon to vary largely from the anode side to the cathode side. This problem is usually called the heel effect. The problem is caused by photons being taken out of an inclined anode surface, which causes uneven filtering of the outgoing useful radiation. In practice, the energy output can be up to 30% higher on the cathode side than on the anode side. These problems are known to a person skilled in the art and previous known X-ray tubes are configured to decrease the negative effects depending on the basic construction of the X-ray tubes. One example of a configuration which reduces the negative influence of the heel effect is, i.e. in thorax imaging, to turn the anode side downwards the body. This is to compensate for the higher absorption of radiation upwards the body.

The above mention problems were previously of less importance because the detector which exclusively was used was the human eye. Geometrically related limits for the human eye is, at daylight and about 25 centimetres viewing distance about 5 line pairs per mm and a contrast resolution of approximately 2% luminescence difference. But, in recent years, the development in electronics and computer technology concerning imaging has made it possible to use far more effective detectors. The new technique makes increased demands on the radiation source. This gives a demand for increased photon density per unit of time and reduced focus size. In addition a photon energy distribution which is uniform over the entire beam field is desired.

There are a number of known X-ray tubes having a rounded anode. US 2004114712 discloses an imaging system using a non-planar anode which makes objects being fluoroscopic scanned in the direction of radiation of an electronic field against a target to be visualised. A remaining problem is that the X-ray tube does not emit focused beams.

EP 1599883 discloses an X-ray tube in which the anode is has a conical shape which is transmitting X-ray radiation in a wide angle. The anode has a thin target layer. One remaining problem is that the X-ray tube does not emit focused beams.

### OBJECTS AND SUMMARY OF THE INVENTION

An object of the present invention is to provide an arrangement for generating X-ray radiation wherein the above mentioned problems, geometric and movement unsharpness and heel effect, decreases or completely disappears.

The above object is achieved by providing an arrangement according to claim 1.

In order to clearly illustrate the present invention a preferred embodiment of the inventive arrangement provided with a part of a spherical anode is described in detail below.

According to the preferred embodiment the arrangement comprises an anode designed as a part of a spherical surface and an electron source, e.g. an incandescent filament, placed in or around the centre of the spherical anode surface. Furthermore, the arrangement comprises at least one virtual focus element which is adapted to let out generated photons to, what herein is designated as, the useful beam field.

An arrangement according to the present invention has a real focus surface (electron target area) which is larger than focus surfaces generated by presently known X-ray tube constructions with inclined anode surface. Accordingly, an increased radiation amount per unit of time is achieved by an arrangement according to the invention. The presumption is that the acceleration voltage between the cathode and the anode is equal and that the electron density per anode surface unit is equal. The virtual focus element can be adapted to specific field of application. When imaging movable objects a high photon density is given priority and when imaging small non-movable details a small focus is given priority. The result of this is that time and geometry related imaging errors are avoided. When generating useful radiation with the arrangement according to the invention, the photons are furthermore equally distributed in respect of mass and energy in the beam field, which results in that the energy dependence of the detector does not affect the image quality.

The focus element can be designed as, among others, a point focus, multiple point focus, slit focus or as a multi focus.

Another advantage of the invention is that the virtual focus of the X-ray tube can be adapted to therapy for tumours close to skin surface, which makes it possible to produce equipment to a lower cost compared to generally used high-energy accelerators.

The arrangement is unique because the real focus surface (electron target area) on the anode is larger than the area of the opening in the virtual focus.

### DESCRIPTION OF THE DRAWINGS

The invention is more closely described with reference to the accompanying drawings, where

FIG. 1 shows an explanatory drawing of an arrangement for generating X-ray radiation where the useful radiation is emitted through a virtual focus.

FIG. 2 shows a simplified figure of an arrangement having a virtual focus where the radiation is emitted through a thin anode. The anode is thick enough to decelerate all the electrons in the anode material but thin enough to absorb only the radiation photons having the lowest energy. In this way the anode material functions as a primary filter to the extracted useful radiation. To a person skilled in the art, the knowledge of calculating the optimal anode thickness is known.

FIG. 3 shows an arrangement having a virtual focus where electrons are accelerated by an electron accelerator and are directed to the anode by a magnetic lens.

FIG. 4 shows an explanatory drawing showing an arrangement having a virtual focus, electron accelerator with 90 degrees deflection and magnetic lens.

FIG. 5 shows an embodiment of the invention, where the arrangement has a spherical anode and two foci for stereo imaging.

FIG. 6 shows an embodiment of the invention, where the arrangement has a spherical anode and two foci for stereo imaging. The radiation is emitted through the anode.

FIG. 7 is an explanatory drawing showing different types of focus shapes.

FIG. 8 is an explanatory drawing showing radiation treatment geometry when treating tumours close to skin surface by using multi foci technique.

### DESCRIPTION OF THE PREFERRED EMBODIMENTS

The invention describes an arrangement for generating X-ray radiation using prior art techniques comprising electron deceleration against an anode surface for generating photons (Bremsstrahlung), but uses a completely new technique to utilize the formed photons for imaging or therapy.

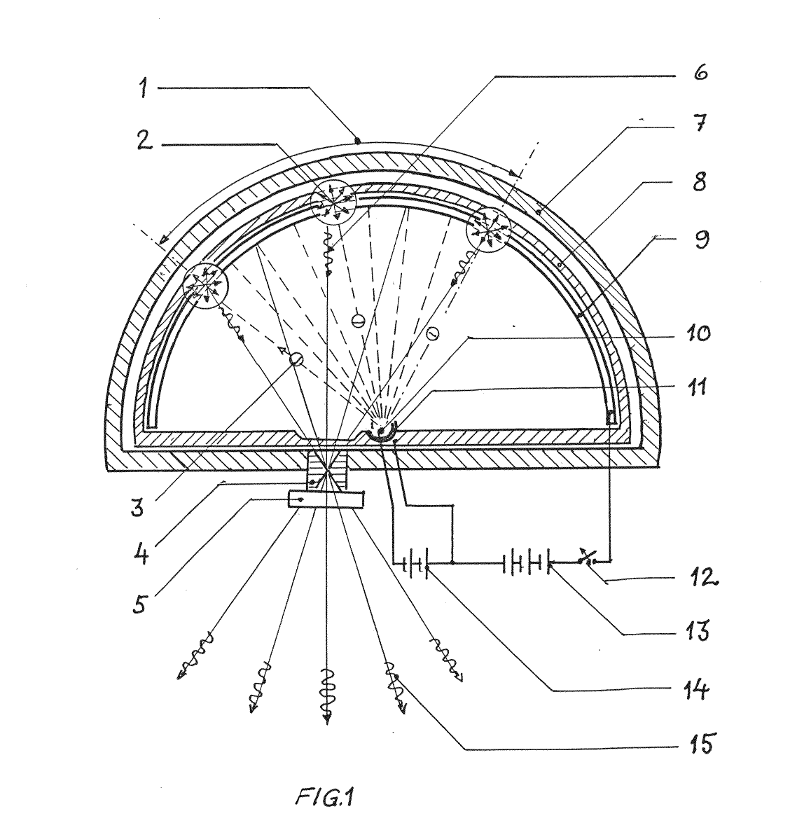

The arrangement according to FIG. 1 may be used for multiple application areas. Only tube voltage, tube current, focus shapes and filtering has to be varied according to the requirements.

With reference to previously known X-ray tubes a starting point may be a focus size of 1 square millimetre, i.e. 1 mm*1 mm, and a maximum tube current of 1000 mA and a tube voltage of 100 kV.

In contrast to previously known focus designs wherein the focus surface is designed to be as small as possible, the invention provides a solution where the real focus surface is designed to be as large as possible. This is achieved by that the arrangement for generating X-ray radiation according to the invention, comprises an anode 9 formed as a part of a sphere. The diameter of the sphere can for example be chosen according to the size of a commonly known anode plate, i.e. about 120 mm. If a quarter of the surface is used as focus surface it will be about 11000 square millimetres. Having an equal distribution of electrons from the cathode to the spherical formed anode 9, the number of deceleration radiation (Bremsstrahlung) photons can be increased by a factor 11000 compared to previously known X-ray tubes, assuming the same electron density per anode surface unit.

At 100 kV acceleration voltages, the deceleration radiation photons are spread equally in all directions. This means that wherever the photons are emitted, on or close to a centre axis of the sphere, an equal distribution from the whole anode surface is achieved for both the photons' energy and the total energy output. The photons may also be emitted behind the anode 22 if the anode 22 is thin enough. In this way the generated beam field will become even more homogenous and symmetric. The small delay, which the photons formed furthest away will get compared to the photons which are closest to the exit opening, the virtual focus of the tube, will have a duration of approximately 0.03 nanoseconds. This makes the invention clearly advantageous when imaging movable organs, for example a heart. A heart, which is the fastest movable organ inside the body when in rest, can move about 0.03 nanometres in 0.03 nanoseconds. The invention achieves that the movement unsharpness becomes insignificant in most imaging situations.

The electron beam from the cathode to the anode 9 can be arranged in multiple ways. Below follows two examples.

The first example is an arrangement for generating X-ray radiation according to the invention, which is adapted, in conformity to previously known X-ray tubes, to use a filament which provides thermal released electrons constituting a space charge around the centre of the anode sphere.

The other example is an arrangement for generating X-ray radiation according to the invention, which uses an electron accelerator, possibly comprising a deflection of for example an angle of 90 degrees, and an magnetic lens for distributing electrons over the complete anode surface.

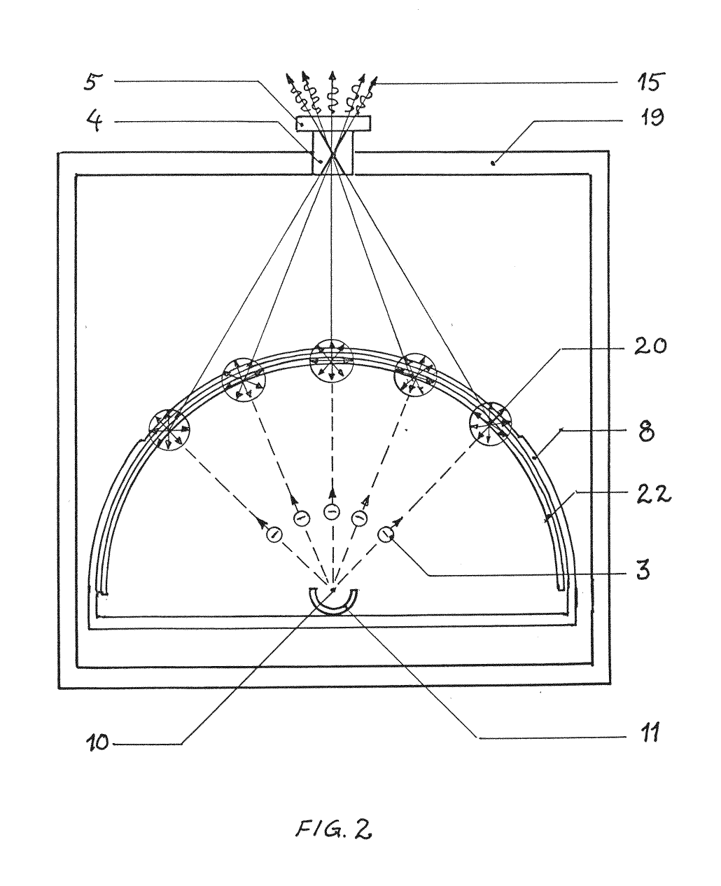

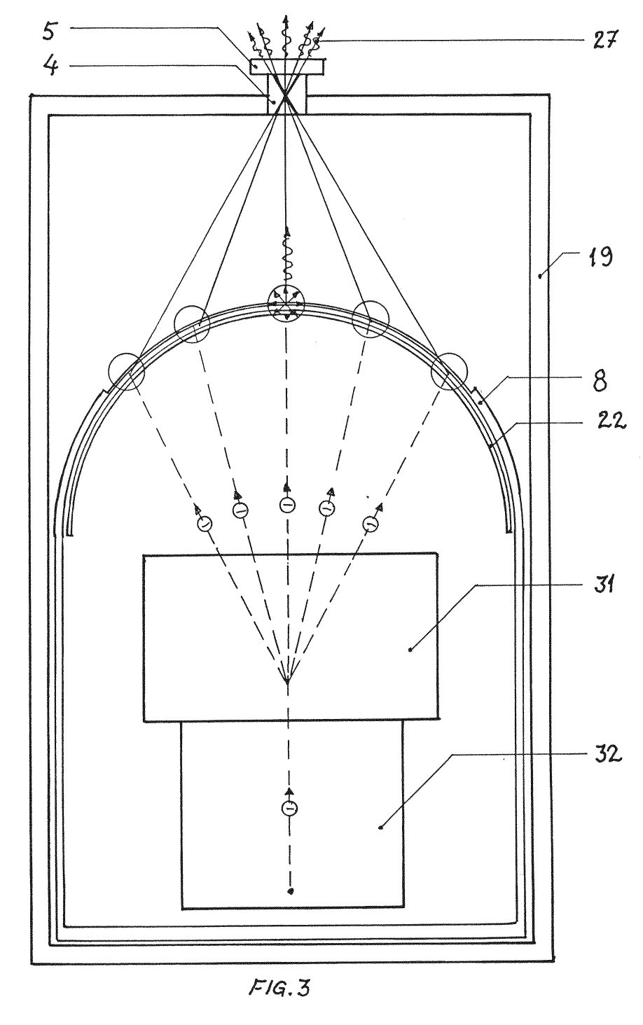

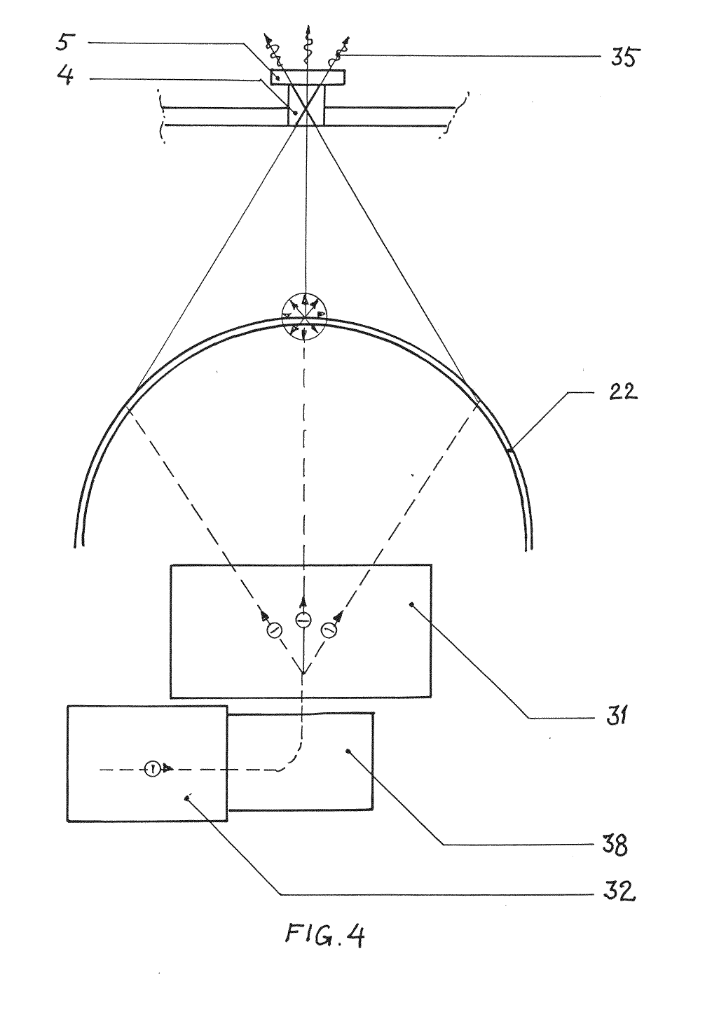

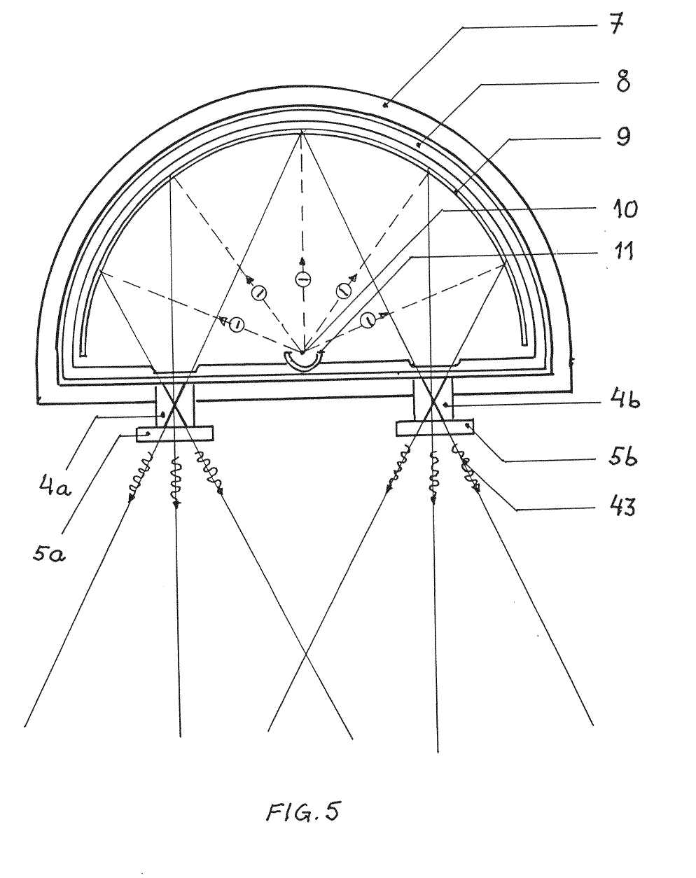

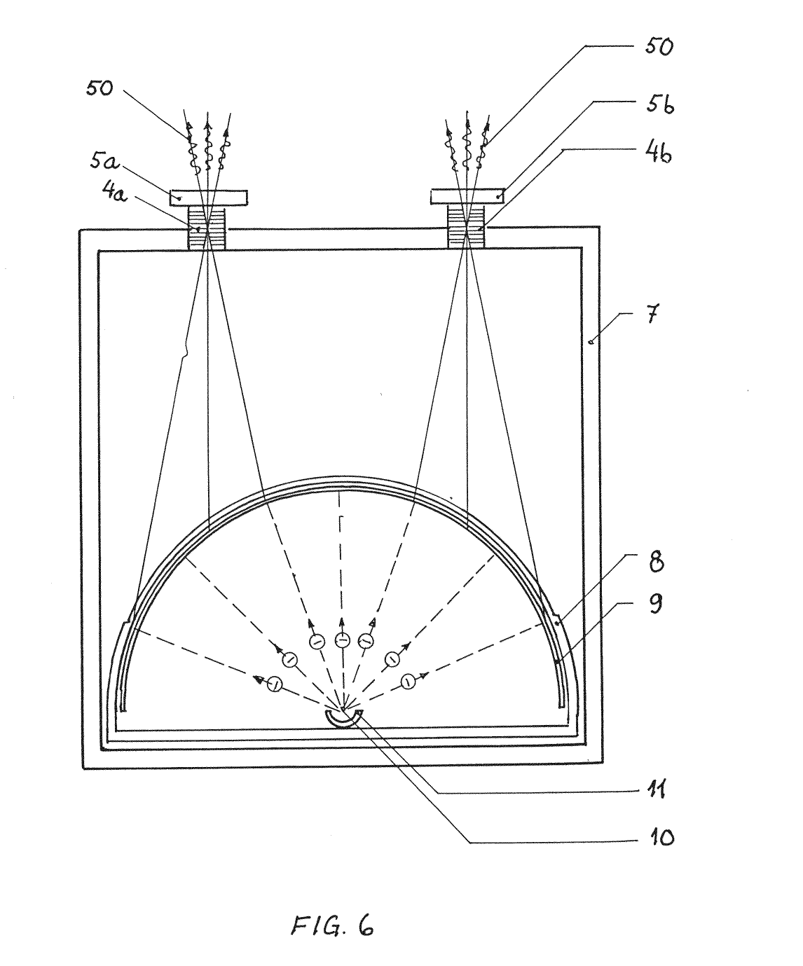

The opening or the openings in one or more of the virtual foci can be formed in many ways. One opening in a virtual focus, independent of in which direction the useful radiation is emitted, can for example be formed as a double funnel, indicated in FIG. 1, FIG. 2, FIG. 3, FIG. 4, FIG. 5 and FIG. 6. However, the opening or openings can be varied depending on the application.

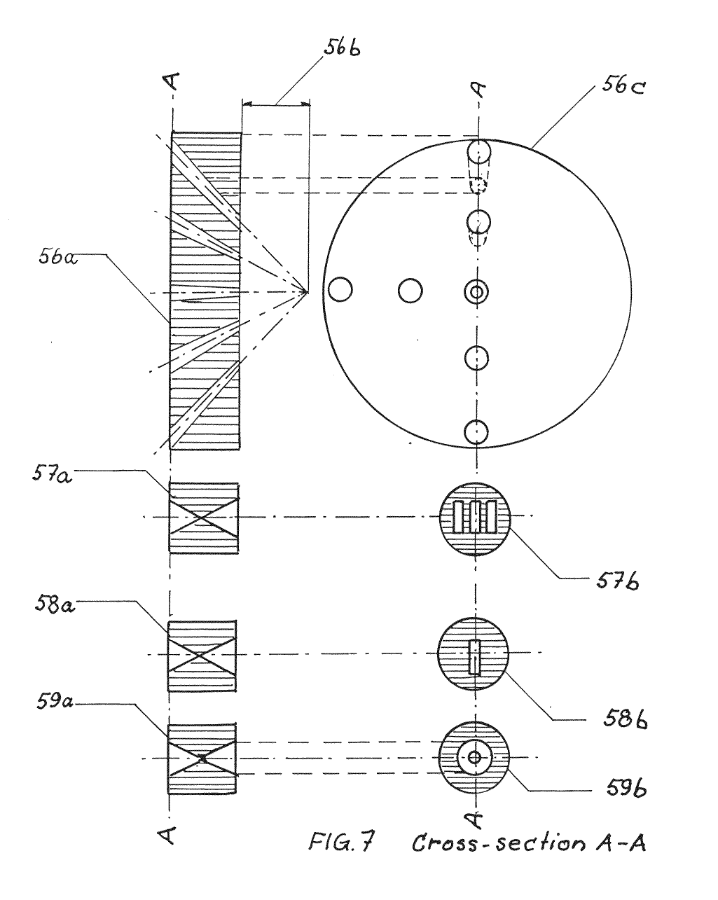

Examples of different forms of the openings are shown in FIG. 7. The openings can be adapted to point shaped shadow imaging, slit for sectional imaging, double point shaped for stereo imaging, multi opening shape with variable energy depth for therapy.

Each virtual focus may be provided with a filter package 5, suitable for a particular imaging or therapy session. The filter 5 is adapted in accordance to well established theories.

All example arrangements must include a vacuum shell containing vacuum and a radiation protection around the area where radiation is produced. All example arrangement can also include one or more filter(s) chosen according to the specific field of application for the arrangement.

FIG. 1 shows an explanatory drawing of an arrangement for generating X-ray radiation with virtual focus 4. The arrangement for generating X-ray radiation comprises a spherical formed anode 9. The cathode comprises an electron source 10, e.g. a filament, placed in or symmetrically around the centre of the anode sphere. Advantageously the cathode comprises a focusing reflector 11. The reflector's task is to guide and distribute the electrons from the cathode to the anode surface. The virtual focus 4 is, according to one embodiment, arranged somewhat besides the centre of the spherical anode 9. The real focus surface 1 is a part of the surface of the spherically formed anode. The deceleration radiation 2 is generated when electrons are decelerated against the anode material. Further, in FIG. 1, is shown electrons 3 accelerated from the cathode filament to the anode. The arrangement comprises a virtual focus 4 of an eligible size and shape. At the virtual focus a filter package 5 can be placed chosen according to the specific range of application for the arrangement. A resulting useful radiation 15 is emitted and distributed through the virtual focus 4. The arrangement must comprise some type of radiation protection 7 such that harmful, non-useful radiation does not leave the arrangement. FIG. 1 indicates that an inner sphere of the arrangement, cathode and anode, shall be enclosed by a glass shell or a similar shell of a different material comprising vacuum which prevents the electron trajectories not to be disturbed by collisions against air molecules. The arrangement comprises, or is connected to, any type of exposure switch 12, a high-voltage power supply 13 and a power supply for the filament 14 according to previously known techniques.

FIG. 2 is a simplified drawing of an arrangement for generating X-ray radiation with a virtual focus 4 where the radiation is emitted through a thin spherical anode 22. The deceleration radiation 20 is generated in the anode. According to this embodiment, the virtual focus 4 is arranged above the spherical anode 22, and thereby the resulting useful radiation 15 is emitted in a direction above the spherical anode 22. The radiation source 10, for example a filament, and the focusing reflector 11 is also, according to this embodiment, arranged in the centre of the spherical anode 22. FIG. 2 shows further that according to this embodiment, the outer radiation protection 19 is an encapsulation of the inner parts of the arrangement comprising the spherically formed anode 22.

FIG. 3 is an arrangement for generating X-ray radiation with a virtual focus 4 where electrons are accelerated by an electron accelerator 32 and is by a magnetic lens 31 directed to a thin spherical anode 22. The deceleration radiation is generated in the anode. According to this embodiment the virtual focus 4 is arranged above the spherical anode 22, and accordingly the resulting useful radiation 27 is emitted in a direction above the spherical anode 22. According to this embodiment, should the electron beam be evenly dispersed over the spherical anode 22. FIG. 3 further shows that according to this embodiment, the outer radiation protection 19 is an encapsulation of the inner parts of the arrangement comprising the spherical formed anode 22.

FIG. 4 is an explanatory drawing of the arrangement with a virtual focus 4, an electron accelerator 32 with a 90 degrees deflection device 38 and a magnetic lens 31. In one alternative of this embodiment the arrangement comprises a thicker type of anode, similar to the one shown is FIG. 1, where the outgoing useful radiation is emitted through the magnetic lens 31 and potentially through the deflection device 38. This is possible due to that the generated magnetic field is not affected by the X-ray radiation. The radiation protection and the vacuum shell is not shown in FIG. 4, but are similar to the radiation protection 19 and the vacuum shell 8 shown in FIG. 3.

FIG. 5 shows an embodiment of the invention wherein the arrangement has a spherical anode comprising two foci 4a and 4b for stereo imaging. The outgoing useful radiation 43 is emitted through two virtual foci 4a and 4b. Electrons are accelerated from the filament 10 of the cathode to the anode 9. The two virtual focus units 4a, 4b are eligible in size and shape. At the virtual focus units 4a, 4b filter packages 5a, 5b may be arranged, chosen according to the specific field of application for the arrangement. The outgoing useful radiation 43 is distributed through the virtual focus units 4a, 4b. The arrangement comprises some type of radiation protection 7. FIG. 5 indicates that an inner sphere of the arrangement shall be enclosed by a vacuum shell comprising a vacuum 8.

FIG. 6 shows an embodiment of the invention where the arrangement has a thin spherical anode 9 with two foci 4a, 4b for stereo imaging. The radiation is emitted through the anode 9. The two virtual focus units 4a, 4b are eligible in size and shape. At the virtual focus units 4a, 4b filter packages 5a, 5b may be arranged, chosen according to the specific field of application for the arrangement. The outgoing useful radiation 50 is distributed through the virtual focus units 4a, 4b. The arrangement comprises some type of radiation protection 7. FIG. 6 indicates that the inner sphere of the arrangement shall be enclosed by a vacuum shell comprising a vacuum 8.

FIG. 7 is an explanatory drawing showing different types of virtual foci. A multi point focus 56a, for different types of therapies, is shown in FIG. 7. The shape of the multi point focus 56a determines the focusing depth 56b. An example of cross-section A-A 56c of the multi point focus 56a is also shown in FIG. 7.

Further in FIG. 7, a multi slit focus 57a and an example of cross-section A-A 57b of the multi slit focus 57a is shown.

An example of a slit focus 58a is illustrated in FIG. 7. An example of a cross-section A-A 58b of the slit focus 58a is illustrated in FIG. 7.

FIG. 7 is also showing a simplified drawing of a point focus 59a and a cross-section A-A 59b of a point focus 59a.

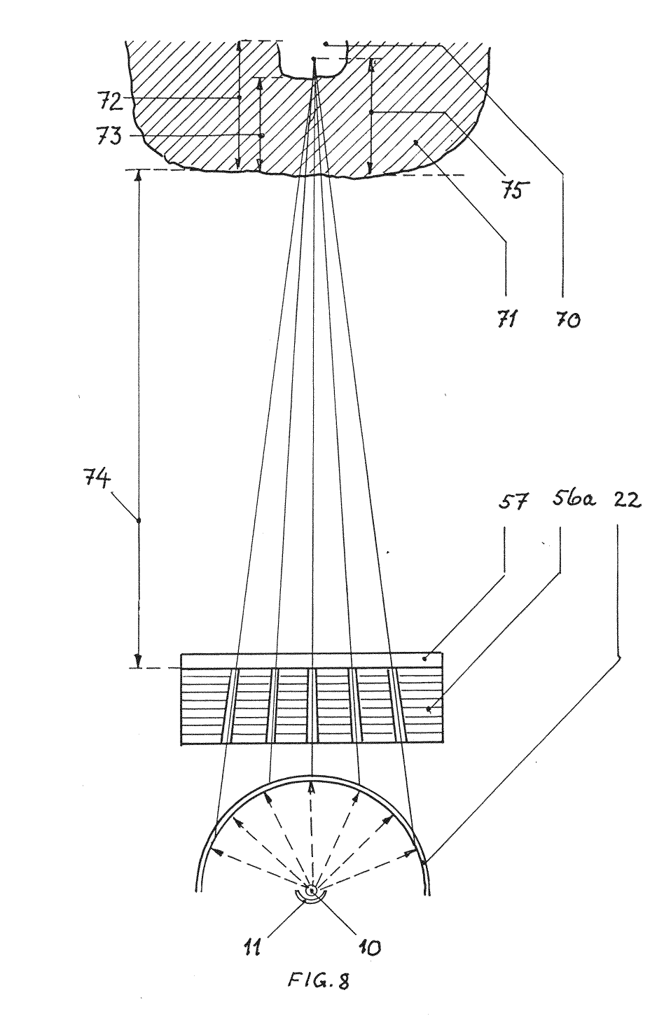

FIG. 8 is an explanatory view of radiation treatment geometry when treating tumour tissue close to skin surface using multi focus technique. The arrangement comprises a filament 10, a focusing reflector 11 and a thin spherical anode 22. A multi point focus 56a may be complemented with a filter 57, adapted for the specific purpose. Further it is shown an area of tumour tissue 70 and an area of healthy tissue 71. The tumour depth is a measure taken from the deepest (farthest from the skin) situated part of the tumour dn 72 and the most superficial (closest to the skin) part of the tumour d0 73. The centre of the treatment depth d 75 is calculated from the patient's skin to the centre of the tumour. The distance to the patient D 74 is the distance from the skin of the patient to the outer part of the multi point focus 56a. Focusing depth is D+d.

The invention is not limited to the above mentioned embodiments, but can be varied in many ways within the scope of the accompanying claims. For example, the anode may be of different shapes; among those may be mentioned, spherical (as discussed above), planar, cylindrical, parabolic etc, as long as the electron source is adopted appropriately. As another example the X-ray tube may have a cooling system if considered necessary or to increase the efficiency.

1-11. (canceled)

12. An arrangement for generation of X-ray radiation wherein the arrangement is adapted for imaging or therapy, comprising
an electron source (10), which is adapted to emit electrons approximately at an equal distribution over an electron target area;
an anode (9) adapted to be said electron target area for said electron source, and said anode comprising a material adapted to generate Bremsstrahlung photons when the emitted electrons from said electron source are decelerated against the surface of said anode, and
at least one virtual focus element (4) comprising at least one virtual focus adapted to let out generated radiation to one or more useful beam field(s) (15), said virtual focus is smaller in area than said electron target area on said anode, and said anode and said virtual focus element are adapted to achieve an approximately even distribution of photons from said anode through said virtual focus, such that
said virtual focus is the area where all said Bremsstrahlung photons' paths are closest to each other for said Bremsstrahlung photons emitted through said virtual focus element and said virtual focus functions as the focus for said useful beam field for said virtual focus element.

13. Arrangement according to claim 12, wherein said electron source (10) comprises a focusing reflector (11), inclined so that the main part of the electrons from said electron source (10) is directed to hit a part of the surface on said anode (9), this part of the surface constitutes a real focus (1).

14. Arrangement according to claim 12, wherein one or more virtual focus element(s) (4) is/are arranged on the same side of the anode (9) as the electron source (10).

15. Arrangement according to claim 12, wherein one or more virtual focus element(s) (4) is/are arranged on the opposite side of the anode (22) as the electron source (10).

16. Arrangement according to claim 12, wherein the arrangement comprises two virtual foci (4a, 4b) arranged at the same distance from the centre of the anode (9).

17. Arrangement according to claim 12, wherein the arrangement comprises a multiple point virtual focus (56a) arranged to focus the exiting X-ray beams into approximately one point.

18. Arrangement according to claim 12, wherein said virtual focus element (4) comprises a funnel-shaped inner surface and having at least one opening at its centre (59) adapted to let out said Bremsstrahlung photons.

19. Arrangement according to claim 12, wherein said virtual focus element (4) comprises at least one slit-shaped opening, adapted to let out said Bremsstrahlung photons, and where the inner surface have two opposite sides sloping against the centre and two opposite straight sides (57, 58).

20. Arrangement according to claim 12, wherein said anode (9) is formed as a part of a spherical surface, and that said electron source (10) is arranged in or symmetrically around the centre of an imaginary sphere where part of the sphere is constituted of said anode.

21. Arrangement according to claim 12, wherein the anode (9) is formed as a part of a planar surface, and that said electron source (10) is arranged to give essentially equal electron density over the whole surface.

22. Arrangement according to claim 12, wherein said anode (9) is formed as a part of a cylindrical surface, and that said electron source (10) is arranged to give essentially equal electron density over the whole surface.

23. Arrangement according to claim 12, wherein said electron source comprises a filament (10).

24. Arrangement according to claim 12, wherein said electron source comprises an electron accelerator (32).

25. Arrangement according to claim 12, wherein the arrangement is fully or partly inside a vacuum shell (8) containing vacuum.

26. Arrangement according to claim 25, wherein one or more virtual focus element(s) (4) is/are outside said vacuum shell (8).

27. Arrangement according to claim 12, wherein the arrangement has a radiation protection (7) to prevent radiation being emitted from the arrangement except through one or more virtual foci.

28. Arrangement according to claim 12, wherein said virtual focus element (4) is provided with a filter package (5).

29. Arrangement according to claim 12, wherein the arrangement includes a cooling system.

30. An arrangement for generation of X-ray radiation wherein the arrangement is adapted for imaging or therapy, comprising
an electron source (10), which is adapted to emit electrons approximately at an equal distribution over an electron target area;
an anode (9) adapted to be said electron target area for said electron source, and said anode comprising a material adapted to generate Bremsstrahlung photons when the emitted electrons from said electron source are decelerated against the surface of said anode, and
said anode (9) is formed as a part of a spherical surface, and that said electron source (10) is arranged in or symmetrically around the centre of an imaginary sphere where part of said sphere is constituted of said anode surface, and
at least one virtual focus element (4) comprising at least one virtual focus adapted to let out generated radiation to one or more useful beam field(s) (15), said virtual focus is smaller in area than said electron target area on said anode, and said anode and said virtual focus element are adapted to achieve an approximately even distribution of photons from said anode through said virtual focus, such that
said virtual focus is the area where all said Bremsstrahlung photons' paths are closest to each other for said Bremsstrahlung photons emitted through said virtual focus element and said virtual focus functions as the focus for said useful beam field for said virtual focus element.
